(19) United States
(12) Patent Application Publication
(10) Pub. No.: US 2024/0111994 A1
(43) Pub. Date: Apr. 4, 2024

(54) OUTPUT FROM A RECURRENT NEURAL NETWORK

(71) Applicant: INAIT SA, Lausanne (CH)

(72) Inventors: Henry Markram, Pully (CH); Felix Schürmann, Grens (CH); Fabien Jonathan Delalondre, Geneva (CH); Daniel Milan Lütgehetmann, Lausanne (CH); John Rahmon, Lausanne (CH); Constantin Cosmin Atanasoaei, Chavannes-pres-Renens (CH); Michele De Gruttola, Geneva (CH)

(21) Appl. No.: 18/487,566

(22) Filed: Oct. 16, 2023

Related U.S. Application Data
(63) Continuation of application No. 16/710,205, filed on Dec. 11, 2019, now Pat. No. 11,816,553.

(51) Int. Cl. G06N 3/044; G06N 3/02; G06N 3/04; G06N 3/08; G06N 3/082

(52) U.S. Cl. CPC G06N 3/044; G06N 3/02; G06N 3/04; G06N 3/08; G06N 3/082

(57) ABSTRACT

Application of the output from a recurrent artificial neural network to a variety of different applications. A method can include identifying topological patterns of activity in a recurrent artificial neural network, outputting a collection of digits, and inputting a first digit of the collection to a first application that is designed to fulfil a first purpose and to a second application that is designed to fulfil a second purpose, wherein the first purpose differs from the second purpose. The topological patterns are responsive to an input of data into the recurrent artificial neural network and each topological pattern abstracts a characteristic of the input data. Each digit represents whether one of the topological patterns of activity has been identified in the artificial neural network.

### CROSS REFERENCE TO RELATED APPLICATIONS

This application is a continuation of U.S. application Ser. No. 16/710,205 filed Dec. 11, 2019 (now allowed), which is incorporated herein by reference in its entirety.

### TECHNICAL FIELD

This invention relates to artificial neural networks, and more particularly to applying the output from a recurrent artificial neural network to a variety of different applications.

### BACKGROUND

Artificial neural networks are devices that are inspired by the structure and functional aspects of networks of biological neurons. In particular, artificial neural networks mimic the information encoding and other processing capabilities of networks of biological neurons using a system of interconnected constructs called nodes. The arrangement and strength of connections between nodes in an artificial neural network determines the results of information processing or information storage by the artificial neural network.

Neural networks can be trained to produce a desired signal flow within the network and achieve desired information processing or information storage results. In general, training a neural network will change the arrangement and/or strength of connections between nodes during a learning phase. A neural network can be considered trained when sufficiently appropriate processing results are achieved by the neural network for given sets of inputs.

Because training is fundamental to the processing performed by neural networks, the output of the processing performed by a neural network is specific to the task(s) for which a neural network has been trained. By way of example, the output from a neural network image classifier can be a yes/no classification of input image. As another example, a neural network that has been trained to steer an automobile will be a set of signals suitable for steering an automobile.

Attempts to generalize the processing performed by a neural network have been made by training the neural network to additional tasks using additional training data. For example, rather than a binary yes/no classification, a neural network image classifier may be able to classify input images into multiple classes. Similarly, the set of conditions under which a neural network may be able to steer an automobile may be broadened by training the automobile to those other conditions. Although the tasks that can be performed have been increased, the nature of output remains specific to the task for which the network has been trained.

Other attempts to generalize the processing performed by a neural network have relied upon multi-stage architectures in which a first stage is trained to perform certain operations and the results of those operations are input into different downstream stages. An example multi-stage architecture is available at github.com/yunjey/pytorch-tutorial/tree/master/tutorials/03-advanced/image_captioning and illustrated in FIG. 1. In the multi-stage architecture 1, an input image 5 is input into a convolutional neural network 10 that has been trained to extract features from images. The presence or absence of the features is denoted in a feature vector 15, which is transformed at a linear transformer 20 to have the same dimension as the input dimension of a long short-term memory (LSTM) decoder network. The LSTM decoder network includes a collection of modules 25 that together caption the transformed feature vector 15. Although the tasks to which the convolutional neural network 10 and the LSTM decoder network have been trained differ, they are still trained by back-propagation-albeit, with multiple targeted tasks. The nature of the output remains intrinsic to the specific training of the neural network.

### SUMMARY

Application of the output from a recurrent artificial neural network to a variety of different applications is described.

In one implementation, a method includes identifying topological patterns of activity in a recurrent artificial neural network, outputting a collection of digits, and inputting a first digit of the collection to a first application that is designed to fulfil a first purpose and to a second application that is designed to fulfil a second purpose, wherein the first purpose differs from the second purpose. The topological patterns are responsive to an input of data into the recurrent artificial neural network and each topological pattern abstracts a characteristic of the input data. Each digit represents whether one of the topological patterns of activity has been identified in the artificial neural network.

In another implementation, a method for constructing an artificial neural network system include providing a recurrent artificial neural network that includes an input configured to input data into the recurrent artificial neural network and an output configured to output representations of whether topological patterns of activity have arisen in the recurrent artificial neural network responsive to the input data, selecting a first proper subset of the representations for input into a first application, and selecting a second proper subset of the representations for input into a second application.

In another implementation, a neural network system includes a recurrent neural network and a first application. The recurrent neural network includes a first region that is configured to receive first data, a second region that is configured to receive second data, and a third region that is configured to receive results of processing by both the first region and by the second regions. The first region is primarily perturbed by the first data and the second region is primarily perturbed by the second data even when both regions are perturbed at the same time. The third region is configured to output indications of the presence of topological patterns of activity that are responsive to the results of the processing by the first region and by the second regions. The first application coupled to receive at least some of the indications of the presence of topological patterns of activity. In another implementation, a neural network system includes a recurrent neural network, a first application, and a second application. The recurrent neural network includes a first region that is configured to receive first data and output indications of the presence of topological patterns of activity that are responsive to the results of the processing by the first region and a second region that is configured to receive second data and output indications of the presence of topological patterns of activity that are responsive to the results of the processing by the first region and by the second regions. The first region is primarily perturbed by the first data and the second region is primarily perturbed by the second data even when both regions are perturbed at the same time. The first application is coupled to receive at least some of the indications of the presence of topological patterns of activity. The second application coupled to receive at least some of the indications of the presence of topological patterns of activity. The first application is designed to fulfil a first purpose. The second application is designed to fulfil a second purpose. The first purpose differs from the second purpose.

These and other implementations can include one or more of the following features. The applications can be, e.g., a clustering application, a captioning application, a control system application, a prediction application, a decision-making application, a salience prediction application, an application for reconstruction of reduced encoding, a language translation application, an encryption application, and a decryption application. A first digit can be drawn from a region of the recurrent artificial neural network that is primarily perturbed by a first class of input data. A second digit can be drawn from a region of the recurrent artificial neural network that is primarily perturbed by a second class of input data. The first class of data can be data that changes relatively rapidly in time and the second class can be data that changes relatively slowly or not at all in time. The first class of data can originate from a first sensor and the second class can originate from a second sensor. The topological patterns of activity can be clique patterns. The clique patterns of activity can enclose cavities. Digits that represent identification of the topological patterns of activity within a plurality of windows of time during which the activity of the artificial neural network is responsive to the input of the data into the artificial neural network can be output. The topological patterns of activity can be identified in each of the pluralities of windows of time. At least some of the representations in the first proper subset can be included in the second proper subset. The first proper subset can be selected using machine learning. An output of the second application can be input into the first application. An output of the first application can be selected for input into a third application. An output of the second application can be selected for input into the third application. A third proper subset of the representations can also be selected for input into the third application. The first proper subset can be drawn from a region of the recurrent artificial neural network that is primarily perturbed by a first class of input data. The second proper subset can be drawn from a region of the recurrent artificial neural network that is primarily perturbed by a second class of input data. At least some of the indications received by the first application are the same as at least some of the indications received by the second application. A second application can be included in the neural network system and coupled to receive at least some of the indications of the presence of topological patterns of activity. The first application can be designed to fulfil a first purpose and the second application be designed to fulfil a second purpose. The first purpose can differ from the second purpose. At least some of the indications received by the first application can be the same as at least some of the indications received by the second application.

The details of one or more implementations are set forth in the accompanying drawings and the description below. Other features and advantages will be apparent from the description and drawings, and from the claims.

### DESCRIPTION OF DRAWINGS

FIG. 1 schematically illustrates a multi-stage architecture in which a first stage is trained to perform certain operations and the results of those operations are input into different downstream stages.

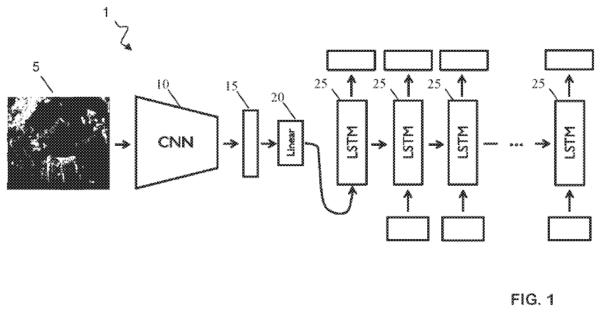

FIG. 2 is a schematic representation of an implementation of an artificial neural network system in which the output from a recurrent artificial neural network is applied to different applications

FIGS. 3 and 4 are representations of patterns of activity that can be identified and “read” to generate a collection of digits from neural network.

FIG. 5 is a graph that represents occurrences of patterns as a function of time.

FIG. 6 is a schematic representation of another approach for inputting data that originates from different sensors into a recurrent neural network.

FIG. 7 is a schematic representation of application of the output from a recurrent artificial neural network to different applications.

Like reference symbols in the various drawings indicate like elements.

### DETAILED DESCRIPTION

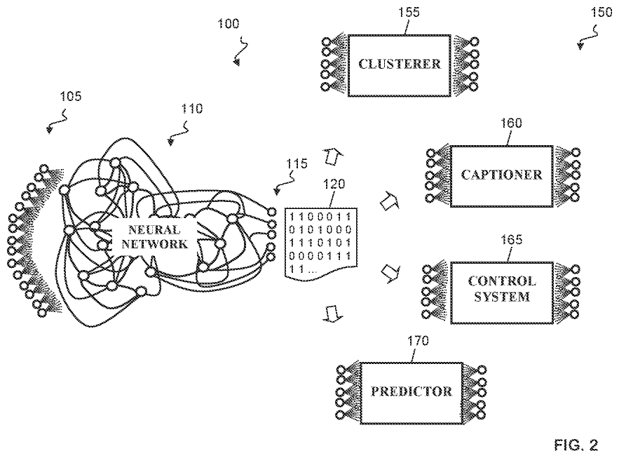

FIG. 2 is a schematic representation of an implementation of an artificial neural network system 100 in which the output from a recurrent artificial neural network is applied to different applications. Neural network system 100 includes a collection of network inputs 105, a recurrent neural network 110, a collection of network outputs 115, and a collection 150 of different applications 155, 160, 165, 170. In some cases, neural network inputs 105 receive data that originates from a variety of diverse sensors such as, e.g., transducers that convert different physical properties into data or devices that sense only certain types of data, such as, e.g., a device that senses the content of a document or data stream. Recurrent neural network 110 processes and abstracts even such diverse input data into a common representation 120 that is output over outputs 115 and suitable for input into multiple, diverse applications 155, 160, 165, 170. In this, recurrent neural network 110 resembles a biological brain in that even diverse input data (e.g., vision, sounds, smells) can be abstracted into a “universal representation” that is applied to different diverse applications and used for, e.g., movement, language, and/or further abstraction.

### Network Inputs 105

In more detail, in the illustrated implementation, inputs 105 are schematically represented as a well-defined input layer of nodes that each passively relay the input to one or more locations in neural network 110. However, this is not necessarily the case. For example, in some implementations, one or more of inputs 105 can scale, delay, phase shift or otherwise process some portion or all of the input data before data is conveyed to neural network 110. As another example, data may be injected into different layers and/or edges or nodes throughout neural network 110, i.e., without a formal input layer as such. For example, a user can specify that data is to be injected into specific nodes or links that are distributed throughout network 110. As another example, neural network 110 need not be constrained to receiving input in a known, previously defined manner (e.g., always injecting a first bit into a first node, the second bit into a second node, . . . etc.). Instead, a user can specify that certain bits in the data are to be injected into edges rather than nodes, that the order of injection need not follow the order that the bits appear, or combinations of these and other parameters. Nevertheless, for the sake of convenience, the representation of inputs 105 as an input layer will be maintained herein.

In some implementations, neural network 110 can receive data that originates from multiple, different sensors over inputs 105. The sensors can be, e.g., transducers that convert different physical properties into data or devices that sense only data, such as, e.g., a device that senses the content of a document or data stream. The data may not only originate from different sensors, but may also have different formats and/or characteristics. For example, certain classes of data (e.g., video or audio data) may change relatively rapidly in time or “stream,” whereas other classes of data (e.g., a still image or temperature) may change relatively slowly or not at all.

For example, the input data can include one or more of sound data that originates from, e.g., a microphone, still image data that originates from, e.g., a still camera, video data that originates from, e.g., a video camera, and temperature data that originates from, e.g., a temperature sensor. This is for illustrative purposes only. The input data can include one or more of a variety of other different types of data including, e.g., pressure data, chemical composition data, acceleration data, electrical data, position data, or the like. In some implementation, the input data can undergo one or more processing actions prior to input into neural network 110. Examples of such processing actions include, e.g., non-linear processing in an artificial neural network device.

### Recurrent Neural Network 110

In recurrent neural networks, the connections between nodes form a directed graph along a temporal sequence and the network exhibits temporal dynamic behavior. In some implementations, recurrent neural network 110 is a relatively complex neural network that is modelled on a biological system. In other words, recurrent neural network 110 can itself model a degree of the morphological, chemical, and other characteristics of a biological system. In general, recurrent neural networks 110 that are modelled on biological systems are implemented on one or more computing devices with a relatively high level of computational performance.

In contrast with, e.g., traditional feedforward neural networks, recurrent neural networks 110 that are modelled on biological systems may display background or other activity that is not responsive to input data. Indeed, activity may be present in such neural networks 110 even in the absence of input data. However, upon input of data, a recurrent neural network 110 will be perturbed. Since the response of such a neural network 110 to a perturbation may depend, in part, on the state of neural network 110 at the time that data is input, the response of such a neural network 110 to the input of data may also depend on the background or other activity that is already present in neural network 110. Nevertheless, even though such activity in a neural network is not responsive only to the input of data, it is responsive to input data.

The response of neural network 110 to the input data can be read as a collection of topological patterns. In particular, upon the input of data, neural network 110 will respond with a certain activity. That activity will include:
activity that does not comport with defined topological patterns, and
activity that does comport with defined topological patterns.

The activity in neural network 110 that does not comport with defined topological patterns can in some cases be incorrect or incomplete abstractions of the characteristics of the input data, or other operations on the input data. The activity in neural network 110 that does comport with topological patterns can abstract different characteristics of the input data. Each of the abstracted characteristics may be more or less useful depending on the application. By limiting representation 120 to representation of certain topological patterns, both incorrect or incomplete abstractions and abstraction of characteristics that are not relevant to a particular application can be “filtered out” and excluded from representation 120.

At times, neural network 110 will respond to the input of data that originates from different sensors with one or more topological patterns that are the same, even if other topological patterns are different. For example, neural network 110 may respond to either a temperature reading or a still image of a desert with a topological pattern that represents a qualitative assessment of “hot,” even if other topological patterns are also part of the response to each input. Similarly, neural network 110 can respond to the conclusion of a musical composition or a still image of a plate with crumbs with a topological pattern that represents a qualitative assessment of “done,” even if other topological patterns are also part of the response to each input. Thus, at times, the same characteristic may be abstracted from data that has different origins and different formats.

At times, neural network 110 will respond to the input of data that originates from different sensors with one or more topological patterns that represent the synthesis or fusion of the characteristics of the data from those sensors. In other words, a single such pattern can represent an abstraction of the same characteristic that is present in different types of data. In general, the fusion or synthesis of data from different sensors will act to cause such patterns to arise or the strength of the activity of such patterns to increase. In other words, data from different sensors can act as “corroborative evidence” that the same characteristic is present in the diverse input data.

In some cases, topological patterns that represent the synthesis or fusion of the characteristics of data from different sensors will only arise if certain characteristics are present in the data from different sensors. Neural network 110 can in effect act as an AND gate and require that certain characteristics in data from different sensors in order for certain patterns of activity to arise. However, this need not be the case. Instead, the magnitude of the activity that forms a pattern may increase or the timing of the activity may shorten in response to data from different sensors. In effect, the topological patterns of activity- and their representation in representation 120 represent abstractions of the characteristics of the input data in a very rich state space. In other words, the topological patterns of activity and their representation are not necessarily the predefined “results” of processing input data in the sense that, e.g., a yes/no classification is the predefined result yielded by a classifier, a set of related inputs is the predefined result yielded by a clustering device, or a prediction is the predefined result yielded by a forecasting model. Rather, the topological patterns are abstractions of the characteristics of the input data. Although that state space may at times include abstractions such as a yes/no classification, the state space is not limited to only those predefined results.

Further, the topological patterns may abstract characteristics of only a portion (e.g., a particular region of an image or a particular moment in a video or audio stream or a particular detail of the input such as a pixel) of the input data, rather than the entirety of the input data. Thus, the state space of the abstractions is neither limited to either a predefined type of result (e.g., a classification, a cluster, or a forecast), nor to abstractions of the entirety of the input data. Rather, the topological patterns are a tool that allows the processing by a high-dimensional, non-linear, recurrent dynamic system (i.e., neural network 110) to be read. The topological patterns extract correlates of the input data that arise in neural network 110, including correlates that fuse the data into a more complete “whole.” Further, by virtue of the recurrent nature of the neural network, the fusion occurs over time. As initial operations or abstractions are completed, the results of these initial operations or abstractions can be fused with other operations or abstractions that are completed at the same time or even later. The fusion thus occurs at a different, later time than the initial operations or abstractions.

Notwithstanding the different origins and formats, neural network 110 can still abstract characteristics from the data. For example, neural network 110 may abstract:
physical traits (e.g., color, shape, orientation, speed),
categories (e.g., car, cat, dog), and/or
abstract qualitative traits (e.g., “alive” vs. “dead,” “smooth” vs. “rough,” “animate” vs. “inanimate,” “hot” vs. “cold,” “open” vs. “closed”).

If one were to constrain input data to originating from a small number of sensors, it may be unlikely that neural network 110 would abstract the data from that sensor in certain ways. By way of example, it may be unlikely that neural network 110 would abstract temperature data by itself into a pattern of activity that corresponds to a spatial trait like shape or orientation. However, as data from different sensors is input into neural network 110, the perturbations provoked by diverse input data meet each other and can collectively influence the activity in neural network 110. As a result, the neural network 110 may abstract input data into different or more certain patterns of activity.

For example, there may be a degree of uncertainty associated with the presence or absence of a pattern. If the input data includes data from diverse range of sensors, both the diversity of the patterns and the certainty of the patterns may increase as the data that originates from different sensors is synthesized or fused within the neural network 110. By way of analogy, a passenger who is sitting in a train at a train station may look out the window and see an adjacent train that appears to be moving. That same passenger may also, e.g., feel forward pressure from the seat. The fusion or synthesis of this information increases the passenger's degree of certainty that the passenger's train is moving, rather than the adjacent train. When neural network receives diverse input data, the perturbations provoked by that data can collectively be abstracted into different or more certain patterns of activity.

The ability of neural network 110 to process input data from diverse sensors also provides a degree of robustness to the abstraction of that data. By way of example, one sensor of a group may become inaccurate or even inoperative and yet neural network 110 can continue to abstract data from the other sensors. Often, neural network 110 will abstract data from the other sensors into the same patterns of activity that would have arisen had all of the sensors been functioning as designed. However, in some instances, the certainty of those abstractions may decrease. Nevertheless, abstraction can continue even if such a problem should arise.

### Network Outputs 115 and Representation 120

The abstraction of data by neural network 110 can be read from outputs 115 as, e.g., a collection of (generally binary) digits that each represent the presence or absence of a respective topological pattern of activity in neural network 110 responsive to input data. In some case, each digit in representation 120 represents the presence or absence of a respective pattern of activity in neural network 110. Representation 120 is only schematically illustrated and representation 120 can be, e.g., one-dimensional vector of digits, a two-dimensional matrix of digits, or other collection of digits. In general, the digits in representation 120 will be binary and indicate in a yes/no manner whether a pattern of activity is present or not. However, this is not necessarily the case. Instead, in some implementations, the digits in representation 120 will be multi-valued. The values can denote characteristics of the presence or absence of a respective pattern of activity in neural network 110. For example, the values can indicate the strength of the activity or a statistical probability that a specific pattern of activity is in fact present. By way of example, activity that is relatively large in magnitude or that occurs within a relatively short window of time can be considered as indicating that a specific operation has been performed or was likely to have been performed. In contrast, activity that is relatively small in magnitude or that occurs over a relatively longer time can be considered less likely to indicating that a specific operation has been performed.

In any case, the responsive patterns of activity represent a specific operation performed by the neural network 110 on the input data. The operation can be arbitrarily complex. A single digit can thus encode an arbitrarily complex operation and a set of digits can convey a set operations, each with an arbitrary level of complexity.

Further, the topological patterns of activity- and their representation in representation 120—can be “universal” in the sense that they are not dependent on the origin of the data being input into the neural network nor on the application to which representation 129 is applied. Rather, the topological patterns of activity express abstract characteristics of the data that is being input into neural network 110—regardless of the origins of that data.

Typically, multiple topological patterns of activity will arise in response to a single input, whether the input is discrete (e.g., a still photo or a single reading from a transducer that measures a physical parameter) or continuous (e.g., a video or an audio stream). The output representation 120 can thus represent the presence or absence topological structures that arise in the patterns of activity responsive to the input data even in a relatively complex recurrent neural network that is modelled on biological systems.

In the illustrated implementation, outputs 115 are schematically represented as a multi-node output layer. However, outputs 115 need not be a multi-node output layer. For example, output nodes 115 can be individual “reader nodes” that identify occurrences of a particular pattern of activity at a particular collection of nodes in neural network 110 and hence read the output of neural network 110. The reader nodes can fire if and only if the activity at a particular collection of nodes satisfies timing (and possibly magnitude or other) criteria. For example, output nodes 115 can be connected to a collection of nodes in neural network 110 and indicate the presence or absence topological structures based on, e.g., the activity levels of each individual node crossing a respective threshold activation level, a weighted sum of the activity levels of those nodes crossing a threshold activation level, or a non-linear combination of the activity levels of those nodes crossing a threshold activation level.

The information in representation 120 is holographically represented in the sense that information about the value of a single digit is distributed across the values of other digits in the representation 120. In other words, random subsets of digits in representation 120 also contain information about the operations performed by the neural network 110 to input, just at lower resolution than would be present if all the digits in representation 120 were present. As discussed further below, different topological patterns have different degrees of complexity. Some relatively more complex patterns may include relatively less complex patterns. Further, simple patterns can be assembled to more complex patterns. Information about the occurrence of some topological patterns thus inherently includes some information about the occurrence of other topological patterns.

For the sake of convenience, the remainder of the application will refer to the representation 120 as a collection of binary bits and the FIGS. will illustrate them as such. However, it is to be understood that in all cases the digits of representation 120 can also be multi-valued to encode various aspects of the operations performed by the network.

### Application Collection 150

The abstractions of data that are output from neural network 110 can be input either directly or after further processing-into a variety of diverse applications 155, 160, 165, 170. In the illustrated implementation, application 155 is a clustering application, application 160 is a captioning application, application 165 is a control system application, and application 170 is a prediction application. In other implementations, the abstractions of data that are output neural network 110 are input into additional applications, one of more of applications 155, 160, 165, 170 can be omitted, and/or the abstractions of data that are output neural network 110 can be input into different applications of the same type. Examples of other applications include, e.g., decision making, salience prediction, reconstruction of reduced encoding, language translation, encryption, and decryption.

Regardless of the exact nature of the applications, recurrent neural network 110 resembles a biological brain in that the input data is abstracted into a “universal representation” that is applied to different diverse applications and used for, e.g., movement, language, and/or further abstractions.

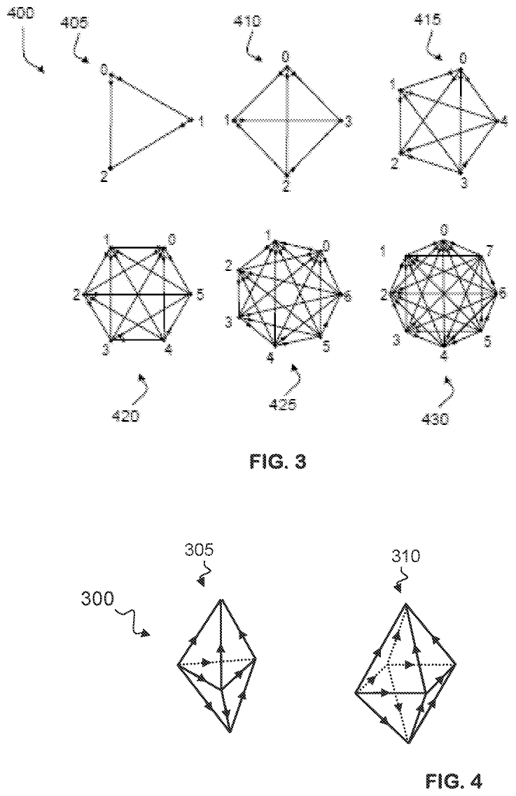

FIG. 3 is a representation of patterns 400 of activity that can be identified and “read” to generate collection 120 from neural network 110 (FIG. 2).

Patterns 400 are representations of activity within a recurrent artificial neural network. To read patterns 400, a functional graph is treated as a topological space with nodes as points. Activity in nodes and links that comports with patterns 400 can be recognized as ordered regardless of the identity of the particular nodes and/or links that participate in the activity. In the illustrated implementation, patterns 400 are all directed cliques or directed simplices. In such patterns, activity originates from a source node that transmits signals to every other node in the pattern. In patterns 400, such source nodes are designated as point 0 whereas the other nodes are designated as points 1, 2, . . . . Further, in directed cliques or simplices, one of the nodes acts a sink and receives signals transmitted from every other node in the pattern. In patterns 400, such sink nodes are designated as the highest numbered point in the pattern. For example, in pattern 405, the sink node is designated as point 2. In pattern 410, the sink node is designated as point 3. In pattern 415, the sink node is designated as point 3, and so on. The activity represented by patterns 400 is thus ordered in a distinguishable manner.

Each of patterns 400 has a different number of points and reflects ordered activity in a different number of nodes. For example, pattern 405 is a 2D-simplex and reflects activity in three nodes, pattern 410 is a 3D-simplex and reflects activity in four nodes, and so on. As the number of points in a pattern increases, so does the degree of ordering and the complexity of the activity. For example, for a large collection of nodes that have a certain level of random activity within a window, some of that activity may comport with pattern 405 out of happenstance. However, it is progressively more unlikely that random activity will comport with the respective of patterns 410, 415, 420 . . . . The presence of activity that comports with pattern 430 is thus indicative of a relatively higher degree of ordering and complexity in the activity that the presence of activity that comports with pattern 405.

Different duration windows can be defined for different determinations of the complexity of activity. For example, when activity that comports with pattern 430 is to be identified, longer duration windows can be used than when activity that comports with pattern 405 is to be identified.

FIG. 4 is a representation of patterns 300 of activity that can be identified and “read” to generate binary digit collection 120 from neural network 110 (FIG. 2).

Patterns 300 are groups of directed cliques or directed simplices of the same dimension (i.e., have the same number of points) that define patterns involving more points than the individual cliques or simplices and enclose cavities within the group of directed simplices.

By way of example, pattern 305 includes six different three point, 2-dimensions patterns 405 that together define a homology class of degree two, whereas pattern 310 includes eight different three point, 2-dimensions patterns 405 that together define a second homology class of degree two. Each of the three point, 2-dimensions patterns 405 in patterns 305, 310 can be thought of as enclosing a respective cavity. The nth Betti number associated with a directed graph provides a count of such homology classes within a topological representation.

The activity represented by patterns such as patterns 300 represents a relatively high degree of ordering of the activity within a network that is unlikely to arise by random happenstance. Patterns 300 can be used to characterize the complexity of that activity.

In some implementations, only some patterns of activity are identified and/or some portion of the patterns of activity that are identified are discarded or otherwise ignored. For example, with reference to FIG. 3, activity that comports with the five point, 4-dimensional simplex pattern 415 inherently includes activity that comports with the four point, 3-dimensional and three point, 2-dimension simplex patterns 410, 405. For example, points 0, 2, 3, 4 and points 1, 2, 3, 4 in 4-dimensional simplex pattern 415 of FIG. 2 both comport with 3-dimensional simplex pattern 410. In some implementations, patterns that include fewer points- and hence are of a lower dimension—can be discarded or otherwise ignored. As another example, only some patterns of activity need be identified. For example, in some implementations only patterns with odd number of points (3, 5, 7, . . . ) or even numbers of dimensions (2, 4, 6, . . . ) are identified. Notwithstanding the identification of only some patterns, information about the activity in the neural network can nevertheless be holographically represented, i.e., at lower resolution that if all patterns of identified and/or represented in an output.

As discussed above, the patterns of activity that are responsive to input data represent a specific operation of arbitrary complexity performed by the neural network 110 on that input data. In some implementations, the complexity of the operation will be reflected in the complexity of the topological pattern. For example, the operation or abstraction represented by the five point, 4-dimensional simplex pattern 415 may be more complex than the operations or abstractions represented by the four point, 3-dimensional and three point, 2-dimension simplex patterns 410, 405. In such cases, digits that represent the presence of activity convey that a set operations or abstractions is performed in neural network 110, where each of these operations or abstractions has an arbitrary level of complexity.

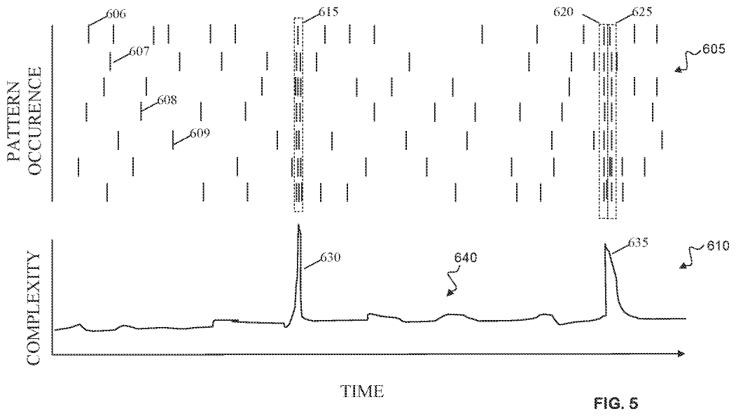

FIG. 5 is a schematic representation of a determination of the timing of activity patterns that have a distinguishable complexity. The determination represented in FIG. 5 can be performed as part of an identification or “reading” of patterns of activity to generate digit collection 120 from neural network 110 (FIG. 2).

FIG. 5 includes a graph 605 and a graph 610. Graph 605 represents occurrences of patterns as a function of time along the x-axis. In particular, individual occurrences are represented schematically as vertical lines 606, 607, 608, 609. Each row of occurrences can be instances where activity matches a respective pattern or class of pattern. For example, the top row of occurrences can be instances where activity matches pattern 405 (FIG. 3), the second row of occurrences can be instances where activity matches pattern 410 (FIG. 3), the third row of occurrences can be instances where activity matches pattern 415 (FIG. 3), and so on.

Graph 605 also includes dashed rectangles 615, 620, 625 that schematically delineate different windows of time when the activity patterns have a distinguishable complexity. As shown, the likelihood that activity in the recurrent artificial neural network matches a pattern indicative of complexity is higher during the windows delineated by dashed rectangles 615, 620, 625 than outside those windows.

Graph 610 represents the complexity associated with these occurrences as a function of time along the x-axis. Graph 610 includes a first peak 630 in complexity that coincides with the window delineated by dashed rectangle 615 and a second peak 635 in complexity that coincides with the window delineated by dashed rectangles 620, 625. As shown, the complexity represented by peaks 630, 635 is distinguishable from what can be considered to be a baseline level 640 of complexity.

In some implementations, the times at which the output of a recurrent artificial neural network is to be read coincide with the occurrences of activity patterns that have a distinguishable complexity. For example, in the illustrative context of FIG. 5, the output of a recurrent artificial neural network can be read at peaks 630, 635, i.e., during the windows delineated by dashed rectangles 615, 620, 625.

In some implementations, not only the content but also the timing of the activity patterns that have a distinguishable complexity can be output from the recurrent artificial neural network. In particular, not only the identity and activity of the nodes that participate in activity that comports with the activity patterns, but also the timing of the activity patterns can be considered the output of the recurrent artificial neural network. The identified activity patterns as well as the timing when this decision is to be read can thus represent the result of processing by the neural network.

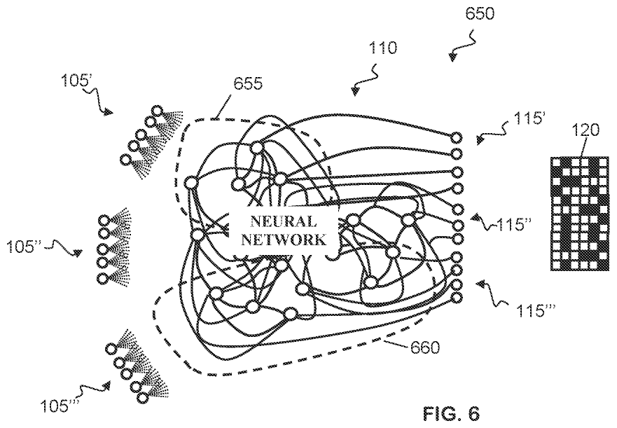

FIG. 6 is a schematic representation of an approach for inputting data that originates from different sensors into neural network 110. In the illustrated implementation, different subsets 105′, 105″, 105′″ of network inputs 105 are dedicated to receiving different types of input data. For example, a first subset 105′ can be dedicated to receiving a first class of input data (e.g., data that originates from a first sensor) whereas a second subset 105″ can be dedicated to receiving a second class of input data (e.g., data that originates from a second sensor).

In some implementations, corresponding “regions” 655, 660 of neural network 110 receive different classes of input data from different subsets 105′, 105″, 105′″ of network inputs 105. For example, in the schematic illustration, regions 655, 660 are shown spatially discrete collections of nodes and edges with relatively few node-to-node connections between each region. This is not necessarily the case. Rather, the nodes and edges of each region 655, 660 can be spatially distributed within neural network 110 but yet receive a particular class of input data.

Regardless the distribution of the nodes in each region 655, 660, the processing in each region 655, 660 is primarily—but not necessarily exclusively—perturbed by the respectively received class of input data. The extent of perturbation can be measured based on the activity that occurs in a region with and without the respective class of input data being present. For example, a region that is primarily perturbed by a first class of input data may respond to the first class of input data in generally the same manner regardless of whether other classes of input data perturb network 110 at the same time. The processing and abstractions performed by each region 655, 660 are primarily influenced by the received class of input data. Nevertheless, the topological patterns of activity that arise in each region 655, 660 can be read as a digit collection 120. The same is true for other regions of recurrent neural network 110.

This schematically represented in neural network system 650 by separately designating different subsets 115′, 115″, 115′″ of network outputs 115. In particular, subset 115′ can be dedicated to outputting digits that represent topological patterns of activity that arise in region 655 of neural network 110, whereas subset 115′″ can be dedicated to outputting digits that represent topological patterns of activity that arise in region 660 of neural network 110. However, subset 115″ outputs digits that are not found in either of regions 655, 660. Indeed, the digits that are output in subset 115″ may represent a fusion or further abstraction of the abstract representations and processing results that arise in regions 655, 660 to a higher level of complexity.

For example, a given digit in subset 115″ may arise if and only if both one or more digits in subset 115′ and one or more digit in subset 115′″ have certain values. The digit in subset 115″ can thus represent an arbitrarily higher level abstraction-both of the abstractions generated in regions 655, 660 but also of the input data itself.

When different regions are primarily perturbed by a single class of input data, the processing in those regions can be tailored to the nature of the input data. For example, the depth of connection and the topology of network loops can be tailored to the input data. In recurrent neural networks that are modelled on biological systems, neuronal dynamics and synaptic plasticity can also be tailored to the input data. The tailoring, e.g., capture different time scales. For example, the processing in a region that is tailored to processing classes of input data that changes relatively rapidly (e.g., video or audio data) can be faster than the processing in a region that is tailored to processing classes of input data that changes relatively slowly or not at all.

Further, when different regions of a recurrent neural network are primarily perturbed by a single class of input data, it is easier for humans to attribute the representations that arise in a recurrent neural network to particular input data. The representations that arise in a particular region can be attributed to the class of input data that primarily perturbs that region. Once the representations that arise in a particular region are attributed, higher level and more complex abstractions that arise in response to the representations in a particular region can also be more easily understood.

Also, training can be targeted to portions of a recurrent neural network that are not primarily perturbed by a single class of input data, i.e., targeted to the portions of a recurrent neural network that fuse the processing results of regions that are primarily perturbed by a single class of input data. In effect, the regions that are primarily perturbed by a single class of input data will generate representations of the input data that are universal—not only for output from the recurrent neural network but also for further abstraction and other operations with the recurrent neural network.

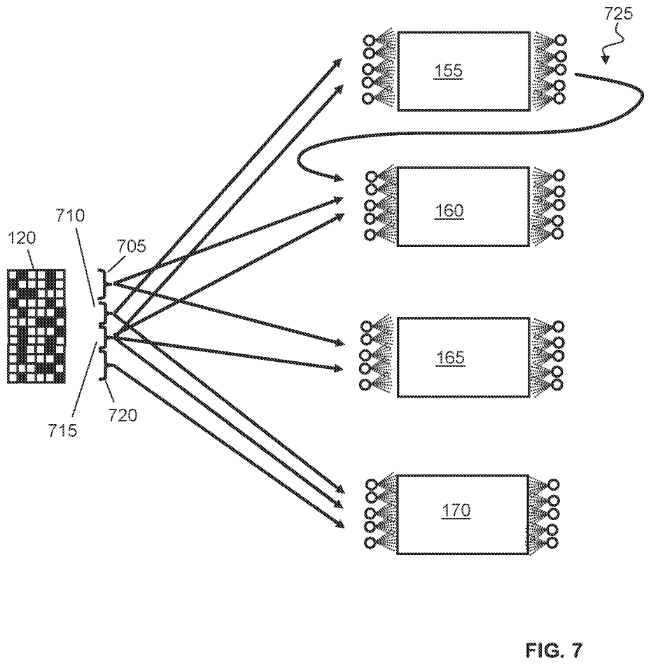

FIG. 7 is a schematic representation of application of the output from a recurrent artificial neural network to different applications 155, 160, 165, 170. A recurrent neural network 110 has processed and abstracted input data into a representation 120. The representation 120 can include different groups of digits 705, 710, 715, 720. In some implementations, each of the different groups of digits 705, 710, 715, 720 can represent activity that arises in a respective region of a recurrent neural network that is primarily perturbed by particular class of input data, such as regions 605, 610 (FIG. 6). In some implementations, one or more of the different groups of digits 705, 710, 715, 720 can represent activity that represents a fusion or further abstraction of the abstract representations and processing results that arise in regions that are primarily perturbed by particular class of input data. For example, or more of the different groups of digits 705, 710, 715, 720 can be output over subset of network outputs 115″ (FIG. 6). Further, in some implementations, some groups of digits can include digits that represent activity that arises in different regions-regardless of whether those regions are primarily perturbed by particular class of input data or fuse or further abstract the representations and processing results that arise in regions that are primarily perturbed by particular class of input data.

Although groups 705, 710, 715, 720 are schematically illustrated as disjoint (i.e., with each digit belonging to one and only one group), this is not necessarily the case. Rather, in some implementations, digits can belong to multiple of groups 705, 710, 715, 720. Further, although groups 705, 710, 715, 720 are schematically illustrated as encompassing all digits in representation 120, this is not necessarily the case. Rather, in some implementations, some digits need not belong to any of groups 705, 710, 715, 720.

In the illustrated implementation, group 705 of digits is input into applications 160, 165. Group 710 is input into applications 155, 170. Group 715 is input into applications 155, 160, 165, 170. Group 720 is input into application 170. Further, the results 725 of application 155 processing groups 710, 715 are input into application 160.

In some implementations, the content of representation 120 is tailored to the particular applications that are to be performed. For example, in the illustrated implementation, if application 170 is no longer to be performed, then group 720 of digits can be omitted or deleted from representation 120. Further, if new applications are to be performed, then new digits or groups of digits can be added to representation 120, e.g., simply by concatenating the new digits onto an existing representation 120.

In some implementations, the output from a recurrent artificial neural network is to be applied to an application that learns. For example, one or more of applications 155, 160, 165, 170 can also be an artificial neural network. In those cases, the learning process can identify the digits that are to be input into the application. For example, supervised learning strategies can be used to identify digits that minimize a cost function. The digits can be identified among the digits in a pre-existing representation 120 or can be added to a pre-existing representation 120 to represent additional patterns of activity.

At times, it will be desired to process the output from a recurrent artificial neural network with a new application (not shown). The new application can be “added” to the artificial neural network system in a variety of different ways. For example, in some instances, the new application can be trained using a group of digits drawn from the existing digits in representation 120 as input. As another example, in some instances, the new application can be trained using, as input, a group of digits that includes digits drawn from the existing digits in representation 120 and new digits that are added to representation 120. As yet another example, in some instances, the new application can be trained using, as input, either or both of existing digits or new digits, as well as the output of an existing application 155, 160, 165, 170. For example, in the context of FIG. 7, application 160 could be trained using results 725 that are output from application 155. Other approaches (such as, e.g., input from multiple existing applications or input from an existing application that itself inputs the output of a second existing application) can also be used. For example, a multi-tiered hierarchy of applications can be assembled, with representation 120 providing a base set of abstractions that are input into a first tier of applications. The processing results of the first tier can then be input into one or more additional tiers-alone or in combination with digits from representation 120.

In effect, recurrent neural network 110 can serve as a preprocessing stage that generates a representation 120 with wide applicability to many different applications. Further, the digits in representation 120 that are output from the recurrent neural network 110—and the particular digits from representation 120 that are input into an application—can be incrementally adapted to improve the processing results—both in existing applications (e.g., applications 155, 160, 165, 170) and in new applications that are added over time.

It is thus not necessary that the exact nature of the relevant topological patterns for a new application be known at the time that the new application is added. Rather, as discussed above, the topological patterns can extract correlates that fuse the input data into a more complete “whole.” The digits in representation 120 that represent the occurrence of the topological patterns can thus include information that is relevant to the new application even if the exact nature of the relevant topological patterns is not known.

In more detail, as a first example, the most relevant abstractions or processing results for a new application may be new fusions of topological patterns whose occurrence or absence is already represented by digits in representation 120. In this case, a learning process can be used to teach recurrent neural network 110 to generate a topological pattern that fuses the already-represented abstractions into a new abstraction. In some cases, the occurrence or absence of a relevant topological pattern can be represented in an additional digit in representation 120.

As another example, the most relevant abstractions or processing results for a new application may be topological patterns whose occurrence or absence is not independently represented by digits in representation 120 but rather is represented in one or more topological patterns that have fused the most relevant abstractions or processing results for the new application with other abstractions or processing results. In other words, a digit in representation 120 may represent the occurrence of a topological pattern that arises only when the most relevant abstraction or processing result for the new application is present along with another topological pattern. As another example, a digit in representation 120 may represent the occurrence of a topological pattern that arises only in the absence of the most relevant abstraction or processing result for the new application.

In these and other circumstances, the digits in representation 120 that represent the occurrence of the topological patterns include information that is relevant to the new application even if the exact nature of the relevant topological patterns is not known. The digits in representation can be incrementally adapted to improve the processing results—both in existing applications (e.g., applications 155, 160, 165, 170) and in the new application.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations have been described. Nevertheless, it will be understood that various modifications may be made. Accordingly, other implementations are within the scope of the following claims.

1-24. (canceled)

25. A method comprising:
inputting input data into a recurrent artificial neural network that acts as a preprocessing stage, wherein the input data comprises multiple different types of data that originate from respective sensors;
identifying topological patterns of activity that occurs amongst groups of three or more nodes in the recurrent artificial neural network, wherein the activity is responsive to the input of the input data into the recurrent artificial neural network and at least a first of the topological patterns abstracts a same characteristic that is present in multiple types of data included in the input data;
outputting a collection of digits, wherein at least a first of the digits represents whether the first of the topological patterns of activity has been identified in the artificial neural network; and
inputting the first digit of the collection into a first application that is designed to fulfil a first purpose and into a second application that is designed to fulfil a second purpose, wherein the first purpose differs from the second purpose.

26. The method of claim 25, wherein the first application is first of the following applications and the second application is a different of the following applications, the following applications being a clustering application, a captioning application, a control system application, a prediction application, a decision-making application, a salience prediction application, an application for reconstruction of reduced encoding, a language translation application, an encryption application, and a decryption application.

27. The method of claim 25, wherein:
a first region of the recurrent artificial neural network that is primarily perturbed by a first class of input data;
a second region of the recurrent artificial neural network that is primarily perturbed by a second class of input data; and
the first digit represents a fusion of processing results from the first region and the second region.

28. The method of claim 27, wherein the first digit indicates that both a first processing result was reached in the first region and that a second processing result was reached in the second region.

29. The method of claim 25, wherein the first class of data changes is video data and the second class of data is audio data.

30. The method of claim 25, wherein the first class of data originates from a first sensor and the second class originates from a second sensor.

31. The method of claim 25, wherein the topological patterns of activity are directed clique patterns of signal transmission activity.

32. The method of claim 31, wherein the directed clique patterns of activity enclose cavities.

33. A method for training an artificial neural network system, the method comprising:
providing a recurrent artificial neural network that includes
an input configured to input data into the recurrent artificial neural network and
an output configured to output representations of whether topological patterns of activity have arisen amongst groups of three or more nodes in the recurrent artificial neural network responsive to the input data, wherein the output is configured to output a first proper subset of the representations for input into a first application and a second proper subset of the representations for input into a second application;
adding a new application to the artificial neural network system; and
training the new application using, as input, a subset of the representations drawn from the representations output from the recurrent artificial neural network.

34. The method of claim 33, further comprising:
adding new digits to the representations output from the recurrent artificial neural network; and
training the new application using the new digits.

35. The method of claim 33, further comprising:
training the training the new application using an output of the first application.

36. The method of claim 33, wherein at least some of the representations in the first proper subset are included in the second proper subset.

37. The method of claim 33, wherein adding new digits to the representations output from the recurrent artificial neural network comprises using machine learning to select the new digits.

38. The method of claim 33, wherein:
the first proper subset is drawn from a region of the recurrent artificial neural network that is primarily perturbed by a first class of input data; and
the second proper subset is drawn from a region of the recurrent artificial neural network that is primarily perturbed by a second class of input data.

39. The method of claim 33, wherein the topological patterns of activity are directed clique patterns of signal transmission activity.

40. The method of claim 33, wherein the first application is first of the following applications and the second application and the new application are different of the following applications, the following applications being a clustering application, a captioning application, a control system application, a prediction application, a decision-making application, a salience prediction application, an application for reconstruction of reduced encoding, a language translation application, an encryption application, and a decryption application.
